(19) United States
(12) Patent Application Publication
(10) Pub. No.: US 2005/0130697 A1
(43) Pub. Date: Jun. 16, 2005

(54) Dual action selector switch for use with cellular telephones

(75) Inventor: Medford Alan Dyer, San Diego, CA (US)

Correspondence Address: David G. Beck;Bingham McCutchen, LLP, Three Embarcadero Center, 18th Floor, San Francisco, CA, 94111, US

(73) Assignee: GN Netcom

(21) Appl. No.: 10/734,831

(22) Filed: Dec. 12, 2003

(51) Int. Cl. H04M 1/00

(52) U.S. Cl. 455/550.1; 455/575.2; 455/569.1

(57) ABSTRACT

A controller for use with a cell phone and an audio source such as a CD player, tape player, radio or MP3 player is provided. In use the controller is coupled to the cell phone, audio source and at least one earphone. The controller includes a switch, the switch simultaneously affecting the cell phone and the audio source. More specifically, when the switch is in a first position, the cell phone is connected and the audio source is disabled, either by decoupling the audio source from the earphones or muting the audio signal emitted by the audio source. When the switch is in a second position, the cell phone is disconnected and the audio source is enabled. Accordingly during use the user may simultaneously answer his or her cell phone and mute (or disconnect) the audio source. The controller may also include a microphone for use with the cell phone and a volume control, the volume control preferably being interposed between the audio source and the earphones.

### BACKGROUND OF THE INVENTION

Portability is an often sought after feature in consumer electronics and devices. Just in the past decade, cellular telephones (i.e., cell phones) have shrunk from briefcase sized to roughly the size of a pack of matches while the size and weight of laptop computers have decreased at the same time that performance has been dramatically improved (e.g., typical laptops now include 40 or more gigabytes of memory, 1 or 2 gigabytes of RAM, one or more rewriteable CD/DVD bays and a 1 to 2 gigahertz processor). In portable music systems, boom boxes have been replaced with relatively high fidelity music systems ranging from CD players to 40 gigabyte portables weighing only a few ounces that are capable of storing 10,000 songs or a multitude of audio books. Current portable gaming devices include high resolution, full color graphics, high speed processors, large memory capabilities, mono or multi-channel audio and sophisticated games. Additionally, short distance wireless networking technology (e.g., Bluetooth and IEEE802.11) has started to make significant in-roads into a variety of areas including telephony (e.g., wireless headsets) and computers (e.g., wireless internet connections).

Technology convergence is another desirable feature in consumer products. For example, personal digital assistants (PDAs) are available that include such features as a calendar, alarm, memo pad, task list, address book, calculator, e-mail, internet and cellular telephone capabilities. Other examples include cell phones that provide text messaging, cell phones that include camera functionality, PDAs that include electronic games, and PDAs that include a mapping capability.

Although convergence in consumer products typically attempts to marry different but compatible technologies in a single device, there have also been attempts using after-market devices to combine the capabilities of individual components. For example, Skullcandy™ currently makes a device that includes a set of earphones (e.g., earbuds or backphones) and a linking device called a LINK™ console. Attached to the LINK™ console is a pair of cables/plugs. One plug is a standard stereo headphone plug and is intended to be plugged into a CD player, MP3 player or other audio device. The other plug is to be plugged into the user's cell phone. The LINK™ console includes a microphone for use with the cell phone, a volume control that varies the volume of the music from the audio device while having no effect on the volume of the speech from the cell phone, and a function button that can be used to control some functions of the cell phone (e.g., connect/disconnect). The device is designed to allow the user to simultaneously hear speech from the cell phone and music (or other audio programming) from the audio device. If the user only wants to hear speech from the cell phone and not music, when a call is received or the user is attempting to place a call, the cell phone must be engaged (i.e., connected) and the volume of the music must be turned off using the volume control. Requiring the user to perform two operations, namely engaging the phone and turning the volume off on the audio device, is often problematic. For example, the user may receive an important phone call but upon answering the phone may find it difficult or impossible to understand the initial speech of the person placing the call until the volume on the audio source is turned down. Alternately, the user may be performing some activity (e.g., bike riding, driving a car) that makes it difficult to operate a switch. Therefore requiring the user to locate and operate multiple switches in order to receive a call and mute the volume from the audio player can be distracting and in some instances, dangerous.

Accordingly, what is needed is an improved system for integrating an audio device and a cellphone. The present invention provides such a system.

### SUMMARY OF THE INVENTION

The present invention provides a controller for use with a cell phone and an audio source such as a CD player, tape player, radio or MP3 player. In use the controller is coupled to the cell phone, audio source and at least one earphone. The controller includes a switch actuator, the switch actuator simultaneously modifying the state or position of a pair of switches, one of which affects the cell phone and the other of which affects the audio source. More specifically, when the switch actuator is in a first position, the cell phone is connected and the audio source is disabled, either by decoupling the audio source from the earphones or muting the audio signal emitted by the audio source. When the switch actuator is in a second position, the cell phone is disconnected and the audio source is enabled. Accordingly during use the user may simultaneously answer his or her cell phone and mute (or disconnect) the audio source. The controller may also include a microphone for use with the cell phone and a volume control, the volume control preferably being interposed between the audio source and the earphones.

A further understanding of the nature and advantages of the present invention may be realized by reference to the remaining portions of the specification and the drawings.

### BRIEF DESCRIPTION OF THE DRAWINGS

FIG. 1 is an illustration of one embodiment of the invention;

FIG. 2 is an illustration of an embodiment in which the controller includes a jack for connecting the controller to earphones;

FIG. 3 is a close-up of one embodiment of a controller compatible with the embodiments shown in FIGS. 1 and 2;

FIG. 4 is an illustration of an embodiment of a controller using a three-position switch;

FIG. 5 is a cross-sectional view of an embodiment of a controller using a slide switch, the figure illustrating the mechanical aspects of the simultaneous switching means;

FIG. 6 is a cross-sectional view of an embodiment of a controller using a push button switch, the figure illustrating the mechanical aspects of the simultaneous switching means; and

FIG. 7 is an illustration of an alternate embodiment of the controller.

### DESCRIPTION OF THE SPECIFIC EMBODIMENTS

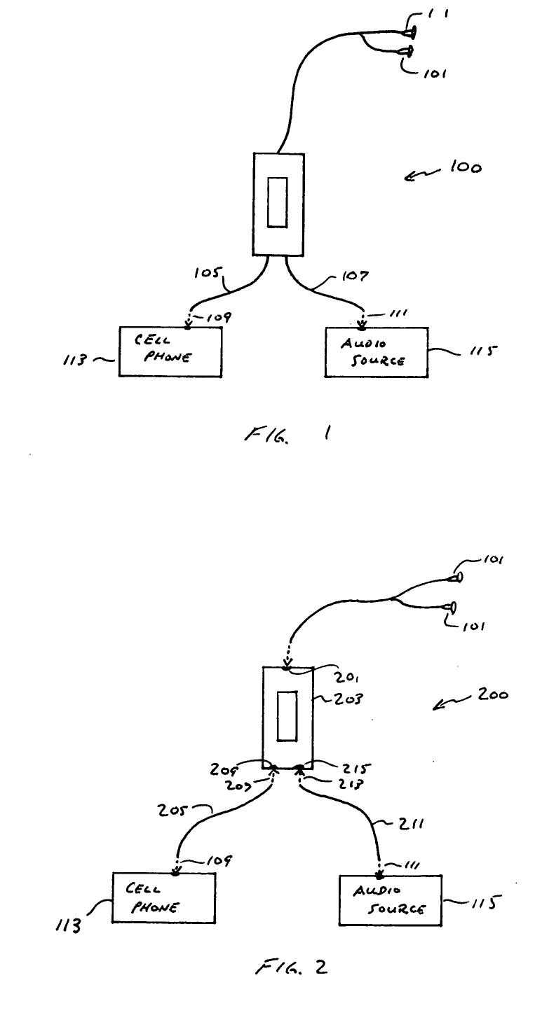

FIG. 1 is an illustration of a preferred embodiment of the invention. System 100 includes at least one earphone 101. Preferably a pair of earphones 101 is used with the invention, thus allowing the user to listen in stereo. Earphones 101 can be in-the-ear type earphones (e.g., eargels, earbuds) or outside-the-ear type earphones (e.g., headphones, backphones). A device controller 103 is coupled to earphones 101, for example by hardwiring the earphones to the controller as illustrated in FIG. 1. Alternately, an earphone jack input 201 can be included on the controller (i.e., controller 203) as illustrated in FIG. 2, thus allowing the user to plug his or her own earphones into the controller. There are several advantages to the embodiment shown in FIG. 2. First, it allows the earphones to be replaced as needed without replacing the entire system. Second, it allows the user to conveniently match the earphones to the activity (e.g., the inconspicuousness of in-the-ear earphones versus the sound quality of outside-the-ear earphones). Third, it provides the user with greater flexibility, allowing the user to only use the system when desired, even allowing the user to loan the system to others without having to loan the user's personal earphones.

In the preferred embodiment shown in FIG. 1, coupled to controller 103 are cables 105 and 107. At the end of cables 105 and 107 are jacks 109 and 111, respectively. Jack 109 is designed to be plugged into a compatible cell phone 113. Due to the differences between cell phones, an adaptor may be required to allow jack 111 to fit the desired cell phone. As such adaptors are well known in the art, further description will not be provided herein. Alternately, system 100 may be one of a plurality of similar systems, each compatible with a specific cell phone manufacturer or a specific cell phone type.

Jack 111 is a standard (i.e., universal) stereo headphone jack and is used to connect controller 103 to an audio source 115. Most portable audio sources (e.g., CD players, tape players, radios, MP3 players, etc.) are compatible with such standard jacks.

To add further versatility to the invention, the cell phone connecting cable, the audio source connecting cable or both may be coupled to controller 103 via jacks as illustrated in FIG. 2. As shown, cell phone cable 205 includes a jack 207 compatible with an input 209 on controller 203 as well as jack 109 compatible with cell phone 113. Similarly, audio source cable 211 includes a jack 213 compatible with an input 215 on controller 203 as well as jack 111 compatible with audio source 115.

There are three primary benefits associated with configuring the system to use separable coupling cables such as those illustrated in FIG. 2. First, it allows a single controller 203 to be compatible with any cell phone 113 or audio source 115 simply by changing the cable. This is of particular importance given the variations in cell phone inputs employed by different manufacturers as well as the frequency by which many cell phone users replace their cell phones, often with cell phones from a different manufacturer. Second, it allows the user to replace a cable if it becomes worn or otherwise damaged without replacing the entire system. Third, it allows the user to customize their set-up with different length cables depending upon their requirements.

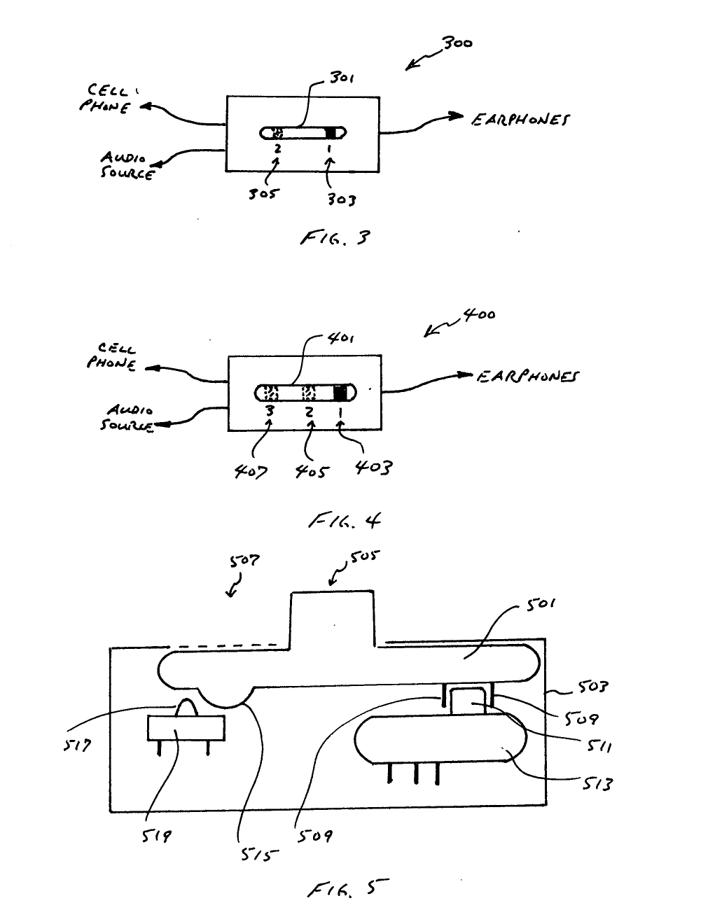

FIG. 3 is a close-up of one embodiment of a controller 300. Although controller 300 is shown with earphone cables as well as cables to connect the controller to both an audio source and a cell phone, it will be understood that the cables can be hardwired to controller 300 as illustrated with system 100, separably coupled to controller 300 as illustrated with system 200, or use some combination thereof.

Included in controller 300 is a switching means 301. Although preferably switching means 301 is a slide switch, other switching means such as toggle switches and push button switches can also be used with the invention. As shown, switching means 301 includes a first position 303 and a second position 305. When switching means 301 is located in the first position as shown, the cell phone is active (i.e., connected) while the audio source is disabled, either by disconnecting the audio source from the earphones or muting the audio signal from the audio source. When switching means 301 is located in the second position as shown in phantom, the audio source is enabled (i.e., connected to the earphones and un-muted) and the cell phone is deactivated (i.e., disconnected). Thus in normal use, switching means 301 would be located in position 305, thus allowing the user to listen to music from the audio source. When a call is received, the user moves switching means 301 from position 305 to position 303, thus simultaneously answering the cell phone call and disconnecting (or muting) the audio source.

Controller 400 shown in FIG. 4 is a variation of controller 300. In this controller switching means 401 can be located in three different positions; 403, 405 and 407. In position 403 the controller operates as controller 300 does in position 303, i.e., connecting the cell phone and disabling the audio source (e.g., by disconnecting or muting the audio source). In position 407 (shown in phantom) the controller operates as controller 300 does in position 305, i.e., deactivating or disconnecting the cell phone while simultaneously enabling the audio source (i.e., connecting an un-muted audio signal from the audio source to the earphones). In position 405 (shown in phantom), switching means 401 activates the cell phone and enables the audio source, thus allowing the user to simultaneously listen to music (or other material from the audio source) and use their cell phone. It will be appreciated that the order of positions 403, 405 and 407 is irrelevant.

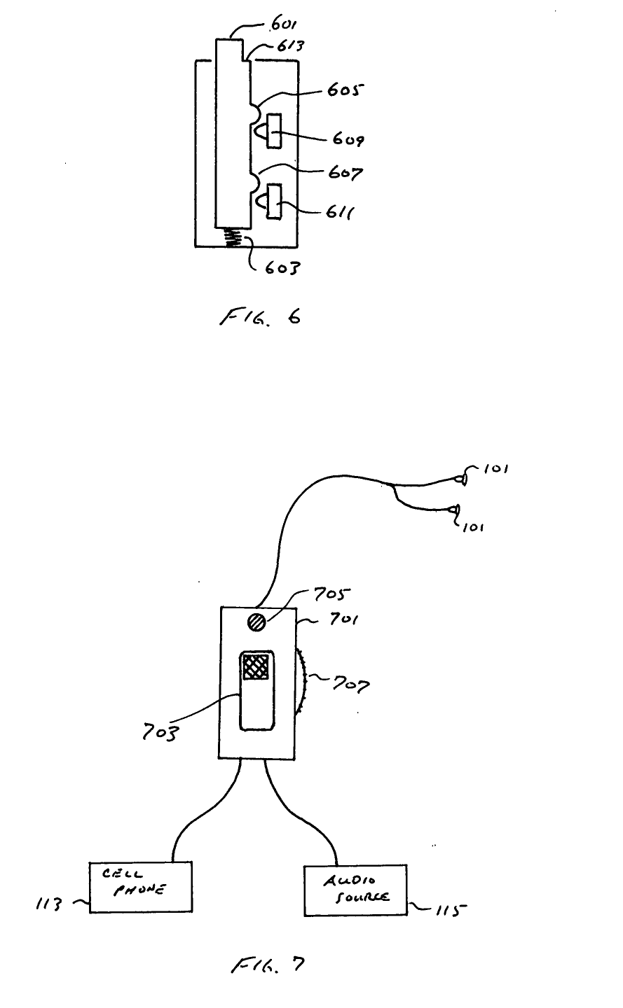

Although there are many different ways in which switching means 301 (or switching means 401) can be designed, one method using a slide switch is illustrated in FIG. 5. As shown, a switch actuator 501 is captured in a housing 503, housing 503 permitting actuator 501 to move from a first location 505 to a second location 507. Portions 509 capture switch member 511 of slide switch 513. As a result, as switch actuator 501 moves from position 505 to position 507, slide switch 513 also moves from a first position to a second position. Simultaneously with the movement of switch actuator 501 from position 505 to position 507, a protrusion 515 on actuator 501 causes the depression of push button 517 on switch 519.

It will be appreciated that the invention is not limited to the switching means illustrated in FIG. 5 and that there are numerous ways of simultaneously actuating two switches that are applicable to the invention. For example, actuator 501 could be used with a pair of slide switches, a pair of push button switches, one or more toggle switches, etc. Similarly, rather than sliding, actuator 501 could be a push button switch, for example as shown in FIG. 6. As illustrated, push button 601 is forced to be in an extended position due to the force applied by a spring member 603. By depressing push button 601, protrusions 605 and 607 depress corresponding push button switches 609 and 611, respectively. Preferably a ridge 613 or other means can be used to lock button 601 in the depressed state.

FIG. 7 is an illustration of an alternate embodiment of the invention using a controller 701. As in the prior embodiments, the controller couples a cell phone 113 and an audio source 115 to a set of earphones, allowing the user to select the source coupled to the earphones using a switching means 703. Additionally this embodiment includes a microphone 705, microphone 705 being used with cell phone 113 when the cell phone is connected. As the invention can also utilize earphones that incorporate a microphone, not every embodiment of the invention requires microphone 705. Accordingly, different embodiments may or may not include microphone 705. Furthermore if the controller is not hardwired to the earphones as illustrated in FIG. 2, controller 701 may also include a second switch (not shown) to engage/disengage microphone 705, thus allowing the user to modify the controller depending upon whether or not the earphones coupled to the controller include a microphone.

In at least one embodiment, the controller also includes a means of adjusting the volume (e.g., means 707 on controller 701). Means 707 is typically a variable potentiometer and may rotate, slide, or otherwise vary the volume level. Means 707 may be coupled to the audio source, the cell phone, or both. In a preferred embodiment, means 707 is only coupled to the audio source.

As will be understood by those familiar with the art, the present invention may be embodied in other specific forms without departing from the spirit or essential characteristics thereof. Accordingly, the disclosures and descriptions herein are intended to be illustrative, but not limiting, of the scope of the invention which is set forth in the following claims.

1. A controller compatible with a cell phone and an audio source, the controller comprising:
a controller housing;
at least one earphone adapted to be coupled to the controller;
an audio source cable adapted to be coupled to the controller and adapted to be coupled to the audio source;
a cell phone cable adapted to be coupled to the controller and adapted to be coupled to the cell phone; and
a switching means within said controller housing, said switching means having at least a first position and a second position, wherein said cell phone is disconnected and said audio source is enabled when said switching means is in said first position, and wherein said cell phone is connected and said audio source is disabled when said switching means is in said second position, wherein an audio signal from said audio source when said audio source is enabled is un-muted and coupled to said at least one earphone.

2. The controller of claim 1, wherein said audio signal from said audio source is muted when said switching means is in said second position.

3. The controller of claim 1, wherein said audio signal from said audio source is disconnected from said at least one earphone when said switching means is in said second position.

4. The controller of claim 1, wherein said switching means has a third position, wherein said cell phone is connected and said audio source is enabled when said switching means is in said third position.

5. The controller of claim 1, wherein said at least one earphone is comprised of a pair of earphones.

6. The controller of claim 1, wherein said at least one earphone is selected from the group consisting of in-the-ear earphones and outside-the-ear earphones.

7. The controller of claim 1, further comprising a microphone mounted to said housing, said microphone coupled to said cell phone via said cell phone cable.

8. The controller of claim 7, further comprising a switch interposed between said microphone and said cell phone, wherein said switch has a first position in which said microphone is coupled to said cell phone and a second position in which said microphone is not coupled to said cell phone.

9. The controller of claim 1, further comprising a volume controller.

10. The controller of claim 9, wherein said volume controller is interposed between said audio source and said at least one earphone.

11. The controller of claim 9, wherein said volume controller is interposed between said cell phone and said at least one earphone.

12. The controller of claim 1, wherein said at least one earphone is coupled to the controller housing via an earphone jack and an earphone jack input.

13. The controller of claim 1, wherein said audio source cable is coupled to the controller housing via an audio source jack and an audio source jack input.

14. The controller of claim 1, wherein said cell phone cable is coupled to the controller housing via a cell phone jack and a cell phone jack input.

15. A controller compatible with a cell phone and an audio source, the controller comprising:
a controller housing;
at least one earphone adapted to be coupled to the controller;
an audio source cable adapted to be coupled to the controller and adapted to be coupled to the audio source;
a cell phone cable adapted to be coupled to the controller and adapted to be coupled to the cell phone; and
a control switch within said controller housing and having a first position and a second position, wherein said control switch in said first position causes a cell phone switch to be in a first position and an audio source switch to be in a first position, wherein said control switch in said second position causes said cell phone switch to be in a second position and said audio source switch to be in a second position, wherein said cell phone switch in said first position connects said cell phone and said cell phone switch in said second position disconnects said cell phone, and wherein said audio source switch in said first position disables said audio source and said audio source switch in said second position enables said audio source, wherein an audio signal from said audio source when said audio source is enabled is un-muted and coupled to said at least one earphone.

16. The controller of claim 15, wherein said audio signal from said audio source is muted when said audio source switch is in said first position.

17. The controller of claim 15, wherein said audio signal from said audio source is disconnected from said at least one earphone when said audio source switch is in said first position.

18. The controller of claim 15, further comprising a microphone mounted to said housing, said microphone coupled to said cell phone via said cell phone cable.

19. The controller of claim 18, further comprising a microphone switch interposed between said microphone and said cell phone, wherein said microphone switch has a first position in which said microphone is coupled to said cell phone and a second position in which said microphone is not coupled to said cell phone.

20. The controller of claim 15, further comprising a volume controller interposed between said audio source and said at least one earphone.

21. The controller of claim 15, further comprising a volume controller interposed between said cell phone and said at least one earphone.
